(19) United States
(12) Patent Application Publication
(10) Pub. No.: US 2014/0249859 A1
(43) Pub. Date: Sep. 4, 2014

(54) DATA EXCHANGE WITH PERSONAL HEALTH RECORD SERVICE

(71) Applicant: MyMedicalRecords, Inc., Los Angeles, CA (US)

(72) Inventor: Robert H. Lorsch, Los Angeles, CA (US)

(73) Assignee: MyMedicalRecords, Inc., Los Angeles, CA (US)

(21) Appl. No.: 14/195,406

(22) Filed: Mar. 3, 2014

Related U.S. Application Data
(60) Provisional application No. 61/771,447, filed on Mar. 1, 2013.
(60) Provisional application No. 61/785,633, filed on Mar. 14, 2013.

(51) Int. Cl. G06F 19/00

(52) U.S. Cl. CPC G06F 19/322
USPC 705/3

(57) ABSTRACT

A method of interoperability for health records includes registering an individual with a personal health record service, generating a medical record number at the personal health record service, and sending health data between the personal health record service and one or more health information technology systems by sending health data and the medical record number to the one or more health information technology systems.

### PRIORITY STATEMENT

This application claims priority to U.S. Provisional Application No. 61/771,447 filed Mar. 1, 2013, hereby incorporated by reference in its entirety.

This application claims priority to U.S. Provisional Application No. 61/785,633 filed Mar. 14, 2013, hereby incorporated by reference in its entirety.

### FIELD OF THE INVENTION

The present invention relates to personal health records. More particularly, but not exclusively, the present invention relates to data exchange with a personal health record service such as a personal health record portal.

### BACKGROUND OF THE INVENTION

Data exchange continues to be an issue in health information technology. Information regarding a particular individual may be fragmented amongst various different health care providers or others.

The personal health record provides a solution which allows an individual to control their own health records, yet it is desirable to expand the role of the personal health record by allowing for seamless data exchange between the personal health record and other systems and types of records such as Electronic Medical Records systems, Electronic Health Record systems and Health Information Exchanges.

What is needed are methods, apparatus, and systems for data exchange between a personal health record service and various health care providers or others across multiple organizations.

### SUMMARY

Therefore, it is a primary object, feature, or advantage of the present invention to improve over the state of the art.

It is a further object, feature, or advantage of the present invention is to provide a personal health record service that is configured for data exchange with any number of outside systems including electronic health record, electronic medical record, health care practice management, and other types of health information technology systems.

It is a still further object, feature, or advantage of the present invention to provide a personal health record service which generates a medical record number that can be consumed by another system.

One or more of these and/or other objects, features, or advantages of the present invention will become apparent from the description that follows. No single embodiment need meet each object, feature, or advantage as different embodiments may have different objects, features, or advantages.

According to one aspect, a method of interoperability for health records includes registering an individual with a personal health record service, generating a medical record number at the personal health record service, and sending health data between the personal health record service and one or more health information technology systems by sending health data and the medical record number to the one or more health information technology systems such as an EMR system.

According to another aspect, a computer readable storage medium includes a medical record number stored thereon, the medical record number generated by a personal health record service and the medial record number identifying a user of a personal health record service. The medical record number may include a destination address for the user, the destination address associated with the personal health record service.

### BRIEF DESCRIPTION OF THE DRAWINGS

FIGS. 1-3 illustrate use cases for a registration process for a personal health record service.

FIG. 4-5 illustrate use cases for assessment forms.

FIG. 6-8 illustrate use cases for an unregistered person walking into a clinic.

FIG. 9-11 illustrate a use case where a patient adds clinical data to a personal health record.

FIG. 12 illustrates a use case where data from an electronic medical record is communicated to a personal health record.

FIG. 13 illustrates scanning of data at a health care provider.

FIG. 14 illustrates a use case where records are sent to a particular folder or a particular chart location in a health information technology system.

### DETAILED DESCRIPTION

Medical Record Numbers (MRNs) are used to identify patients and patient information within an organization. Typically, each provider organization has a Master Patient Index (MPI) for associating each MRN with basic patient demographic information such as name, date of birth, address, and other information. Although unique within a particular organization, different organizations will use different numbering systems with different patient demographic information and different formats. Thus, MRNs have limited utility when health information is exchanged between organizations.

The present invention provides for expanded functionality for a personal health record service such as a personal health record portal. The personal health record portal allows for a user to be in control of their own health records and may be of the type described in U.S. Pat. Nos. 8,301,466; 8,352,287; 8,352,288; 8,121,855; 8,117,646; 8,117,045; and 8,321,240, all of which are hereby incorporated by reference in their entireties. Functionality of the personal health record service may be expanded by generating MRNs at the personal health record service. These MRNs may then be used when exchanging health data with other electronic services.

The personal health record service provides for generating its own medical record numbers. The medical record number may include a lifeline of the user of the personal health record service. The lifeline of the user may include a destination address such as a phone number, email address, or other destination address.
Lifeline_Number=The PHR Account ID (fax/voice number)
Medical Record Number=Lifeline Number+“_{—}”+1 digit indicating family member
e.g. 87712312345_{—}1 Enrollee 87712312345_{—}2 First Dependent or Family Member

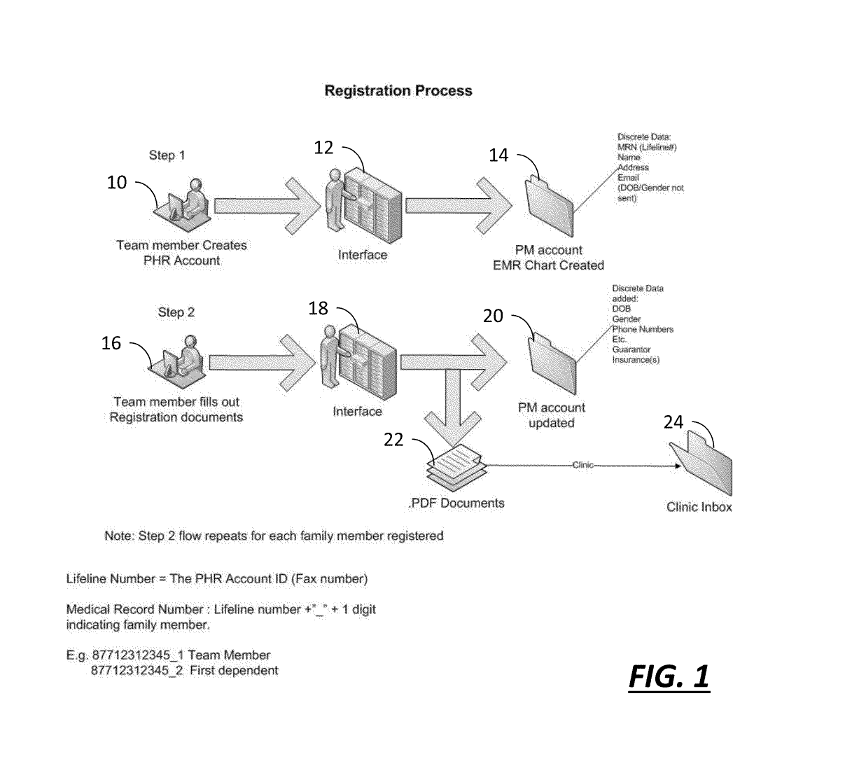

FIGS. 1-3 illustrate a use case for a registration process for a personal health record service. In step 10 an enrollee creates a personal health record account through a personal health record service or personal health record portal. Information is communicated from the personal health record service through an interface 12 to a member account and an electronic medical record (EMR) chart is created. Information associated with the member account may include discrete data such as the MRN, date of birth, name, address, or email address or other demographic data.

In 16 an enrollee fills out or completes registration documents. Information is communicated from the personal health record service through an interface 18 (which may be the same as interface 16) so that in step 20 the primary member account is updated. Discrete data may be added such as date of birth (DOB), gender, phone numbers, guarantors, insurance information, or other information. In addition, in step 22 documents are created which may be stored in an image file format such as PDF and these documents are created to a clinic associated with the registration forms. These documents, may, for example be sent to a clinic inbox 24. The process beginning in step 16 may be completed when the PHR account is a family account with multiple individuals associated with the account.

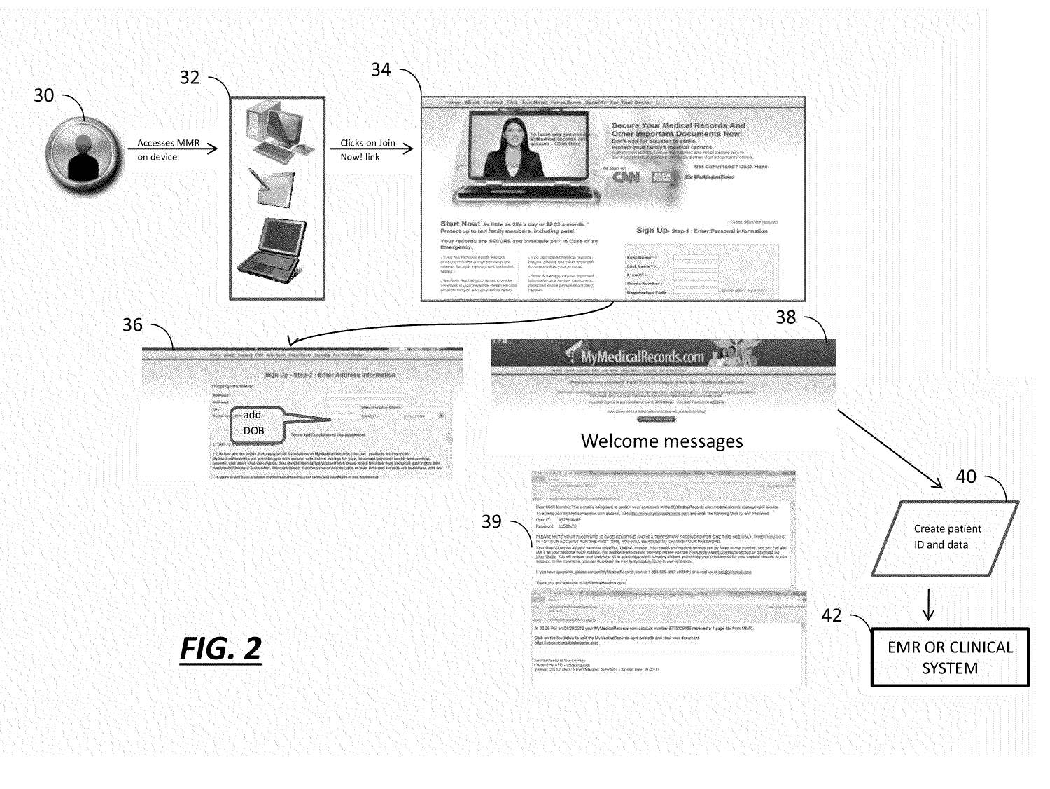

FIG. 2 illustrates that a user 30 may access a personal health record service, such as the MyMedicalRecords.com service using a device 32 which may be a desktop computer, a tablet device, a notebook computer, a smart phone, or other computing device. The user may then select to join or sign-up for the personal health record service and a corresponding screen display 34 may be shown. As a part of the sign-up or registration process, basic information may be collected as shown in screen displays 34, 36. Note that the information collected during the enrollment process may include such information as date of birth, or other information that may be used in the health information exchange service. Screen display 38 confirms that an account has been created and welcome messages 39 may be sent to the user in various ways including via email. In step 40 a patient ID and data may be created which may be communicated to an electronic medical record or EMR, EHR or health information exchange service 42.

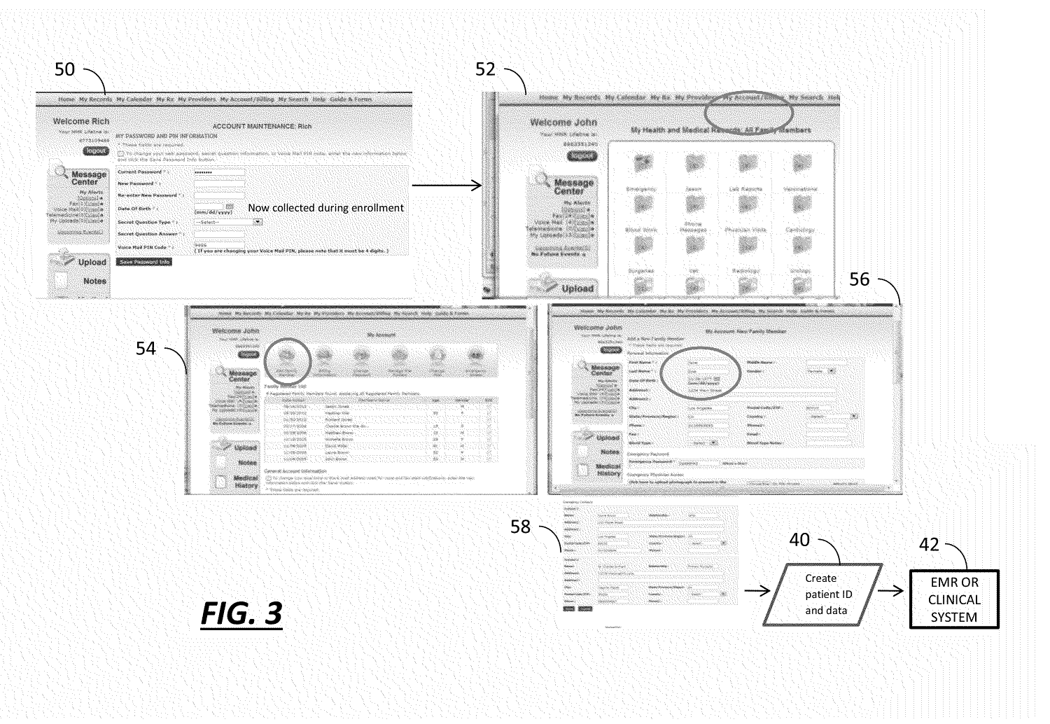

FIG. 3 illustrates a welcome screen 50 where additional information is collected after registration or enrollment. A screen display 52 is shown with different folders in which health records may be placed. Screen displays 54, 56, and 58 illustrate how additional family members may be created through a process which involves adding basic information. In step 40, a patient ID and data may be created for each additional family member. Note that the information collected for each family member includes the information that may be used on a EMR, EHR or health information exchange service to identify the individual.

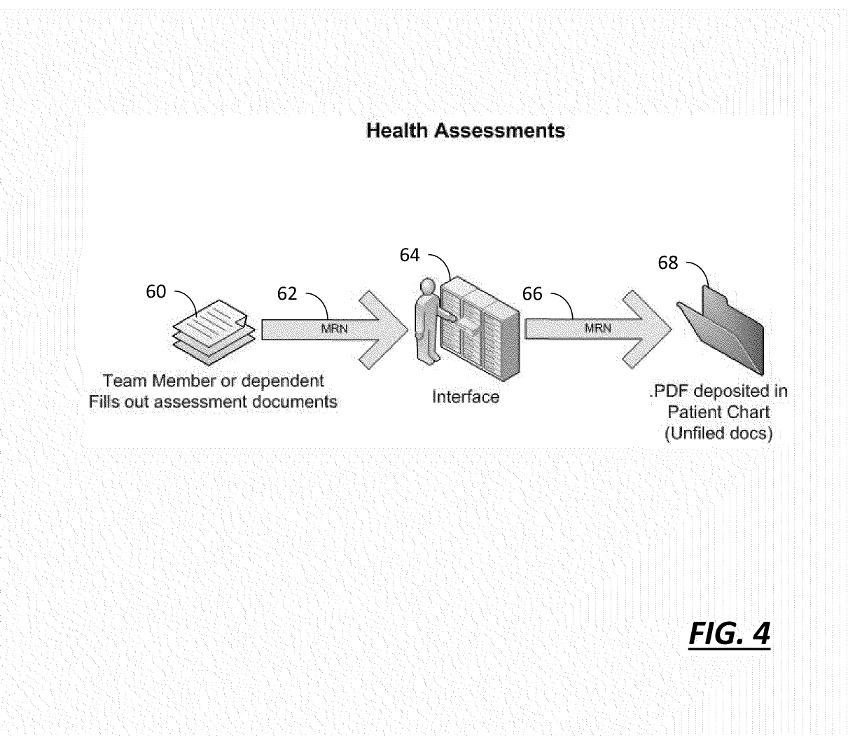

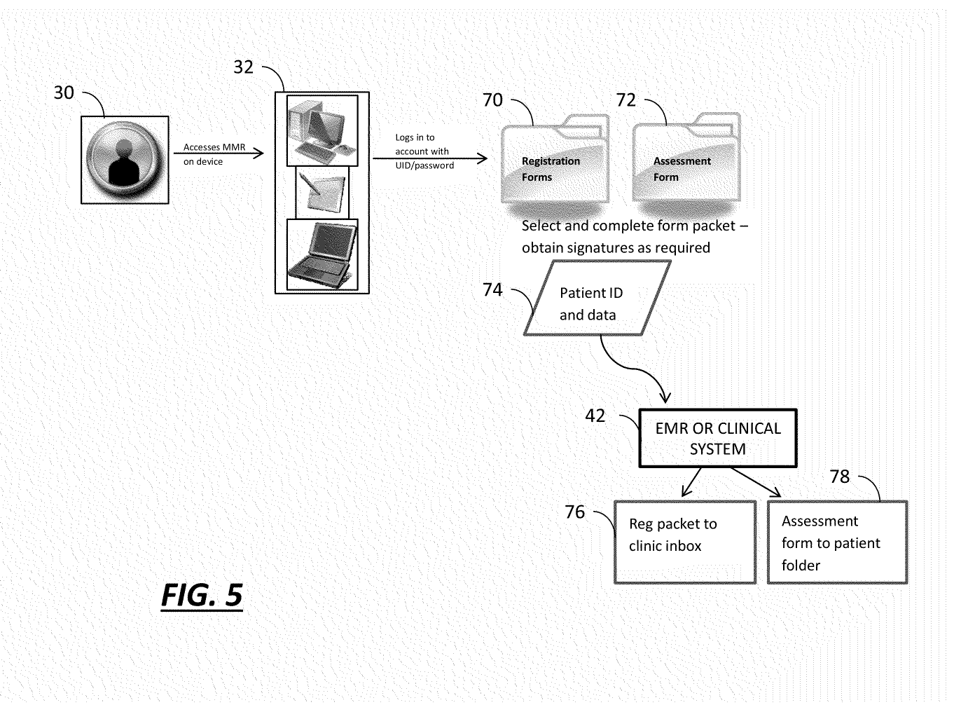

FIGS. 4-5 illustrate use cases for assessment forms. As shown in FIG. 4, in step 60 an individual or a dependent completes or fills out assessment documents. There is an MRN associated with these documents and in step 62 the document and MRN are communicated to an interface 64, such as one associated with a personal health record service. In step 66, the documents and their associated MRN are then deposited into a patient chart associated with the individual.

As shown in FIG. 5, a user 30 can access a personal health record service using a computing device 32 and login using access information such as a user id and a password. Once logged in, various folders may be present containing documents. These folders may include different packets of forms such as a registration forms folder 70 and an assessment form folder 72; each provider can group forms into packets. Within each folder may be various form packets some of which may require signature of the patient, others which may not. In step 74, patient ID and data, in this case completed form packets may be communicated through a EMR, EHR or health information exchange service 42 with the forms in each packet being placed in the appropriate folders in the clinical system as shown in 76 and 78. In addition to the forms being delivered in PDF format, underlying data can be captured and delivered in HL7 format as well or other types of formats.

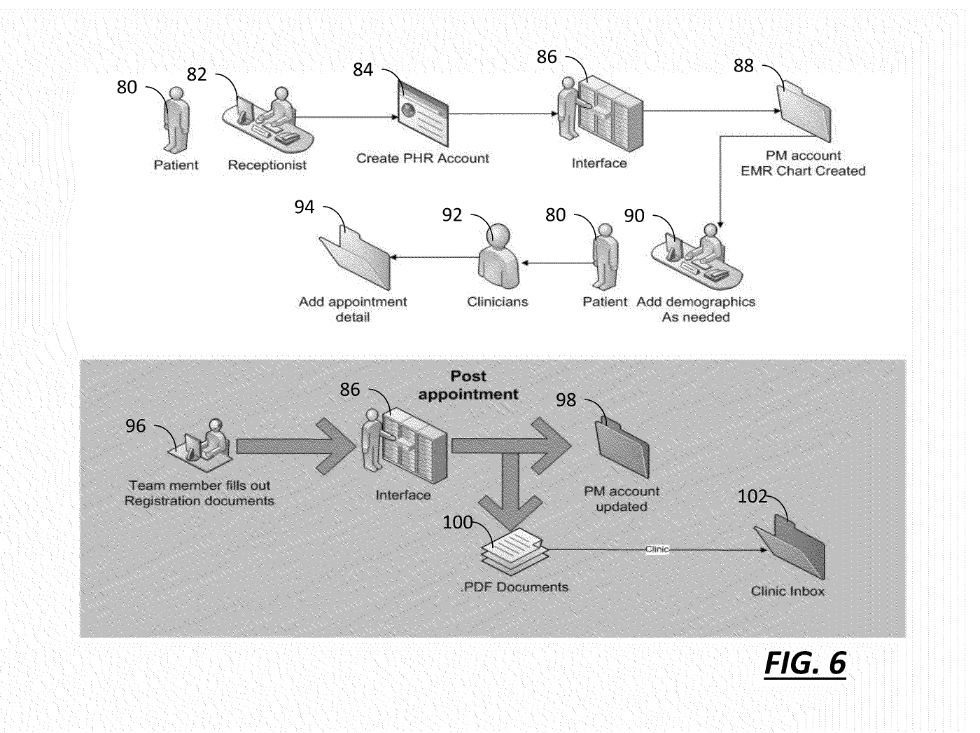

FIGS. 6-8 illustrate use cases for an unregistered person walking into a clinic. As shown in FIG. 6, a patient 80 may be greeted by a receptionist 82 at the office of a health care provider. A personal health record account may then be created for the patient in step 84. It is contemplated that the health care provider may allow the patient to create the account themselves or the receptionist or other personnel may assist. Once created information is communicated through interface 86 and in step 88 a primary member account and electronic medical record (EMR) chart is created. In step 90 demographic information may be added as needed such as by the receptionist. The patient 80 may then interact with one or more clinicians 92 and appointment detail may be added to the system in step 94.

After the appointment, in step 96 the patient or family member may complete the registration documents which are then sent to the interface 86. The documents may be saved in a PDF format or other format and may then be electronically delivered to the clinic inbox 102 of the clinic. In addition, in step 98 the primary member account may be updated. In addition to the forms being delivered in PDF format, underlying data can be captured and delivered in HL7 format as well.

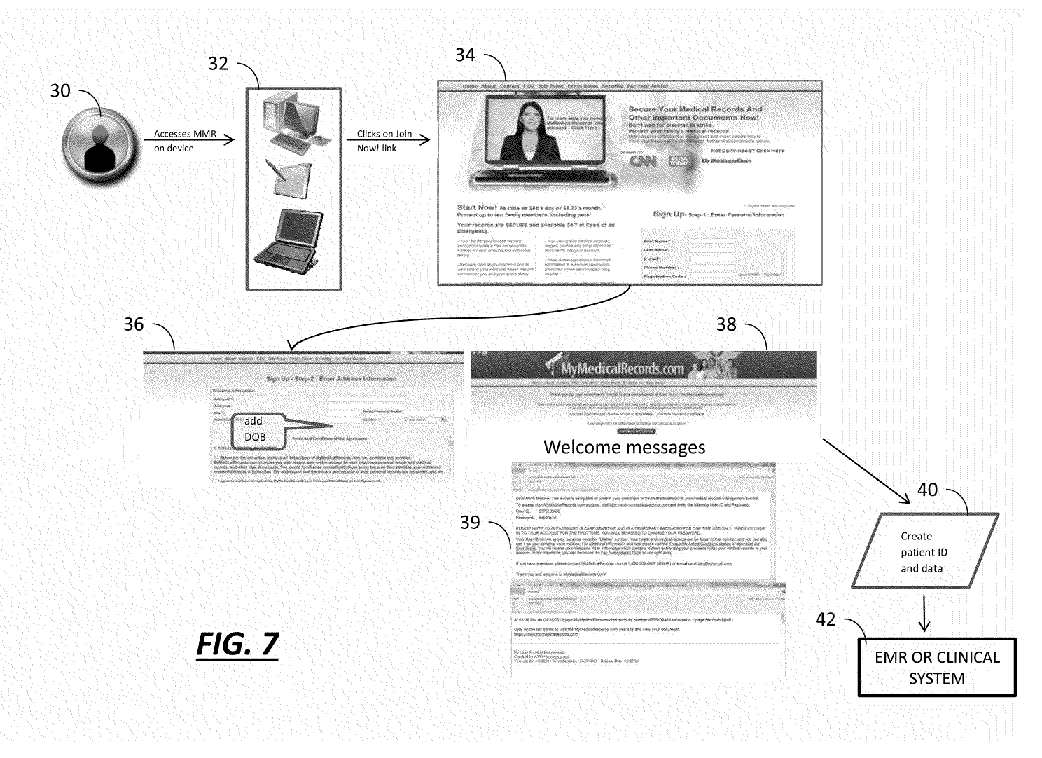

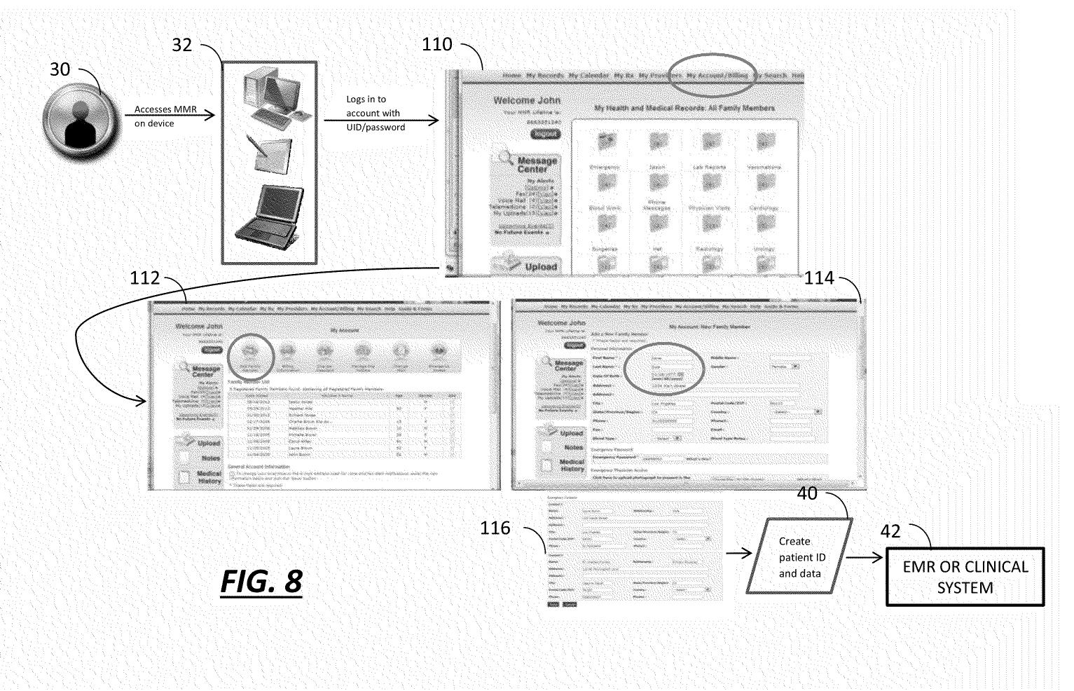

FIG. 7 further shows registration of an unregistered walk-in patient at the clinic and the process may otherwise be the same as that shown in FIG. 3. FIG. 8 illustrates how additional family members may be later added with screen display 110 showing family members, screen displays 112, 114, and 116 showing the addition of family members, step 40 showing the creation of a patient ID and data and communication of that data to a EMR, EHR, health information exchange, or other health information technology system or service.

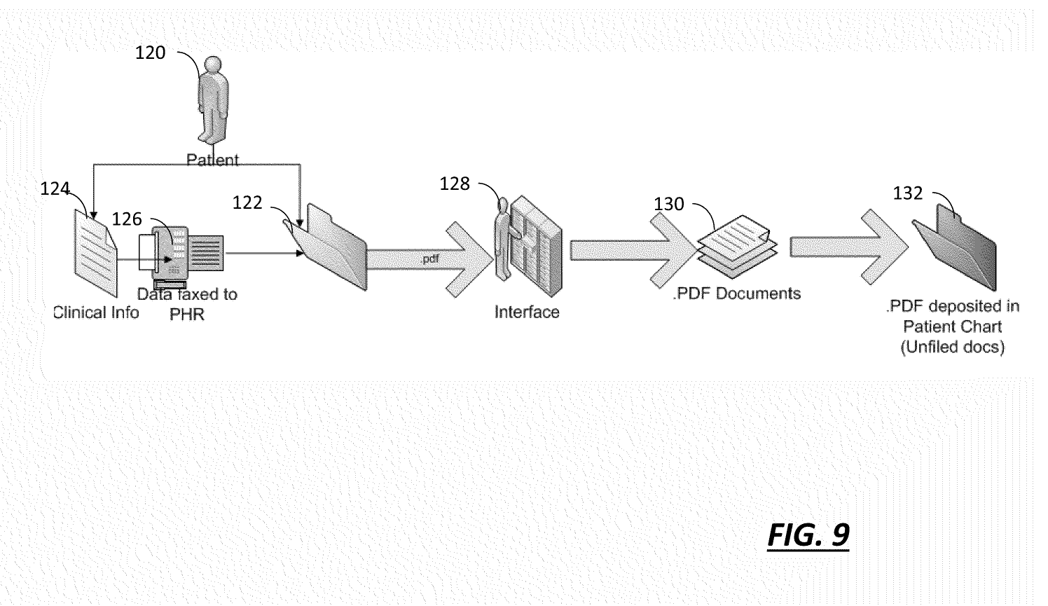

FIGS. 9-11 illustrate a use case where a patient adds clinical data to a personal health record so that it automatically is transmitted to the electronic medical record system or health information exchange system. In FIG. 9, a patient 120 is shown. In addition, clinical information 124 may be faxed using a fax device 126 into a personal health record which may be placed within a personal health record folder. The personal health record may be communicated through interface 128 and the .PDF documents may be deposited in a patient chart.

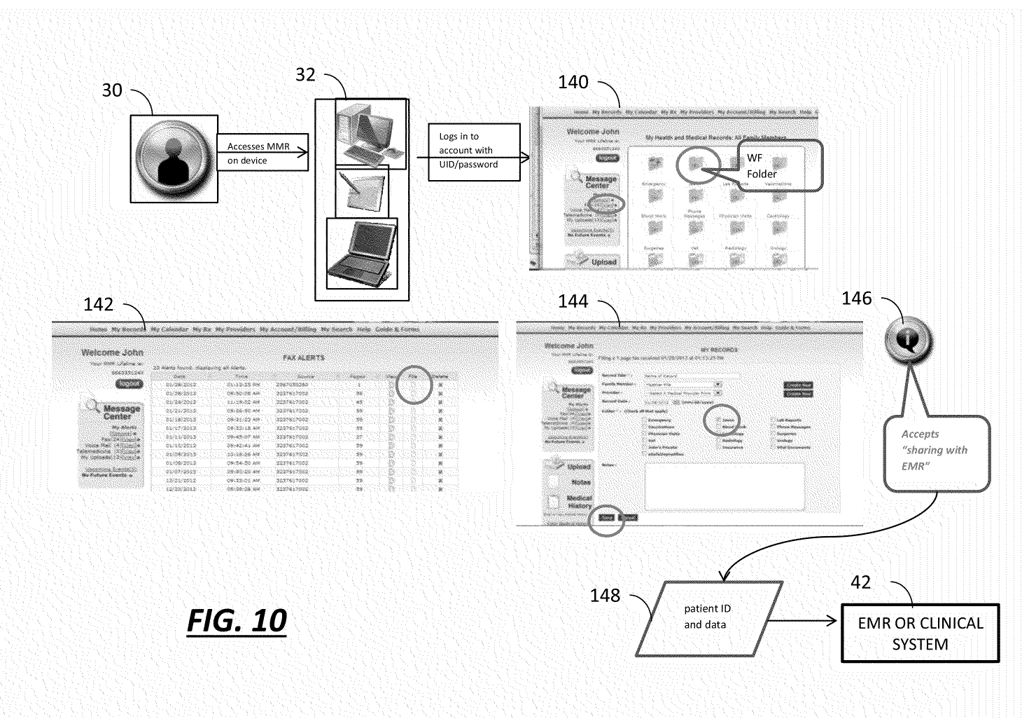

FIG. 10 illustrates how a patient 30 may use a computing device 32 to access health records within one or more folders as shown in screen display 140. The screen display 142 illustrates various incoming faxes and screen display 144 illustrates one example of how a user can then file the incoming record. There is an icon or symbol or other visual indicator or visual element 146 present which can be used to indicate that the patient accepts sharing of the record with an EMR. Where a patient indicates that the patient accepts sharing, then in step 128 patient ID information and the data may be communicated to a EMR, EHR or health information exchange service such as 4medica in step 42. In addition to sending information in image file formats such as PDF, information may be sent in other formats including HL7.

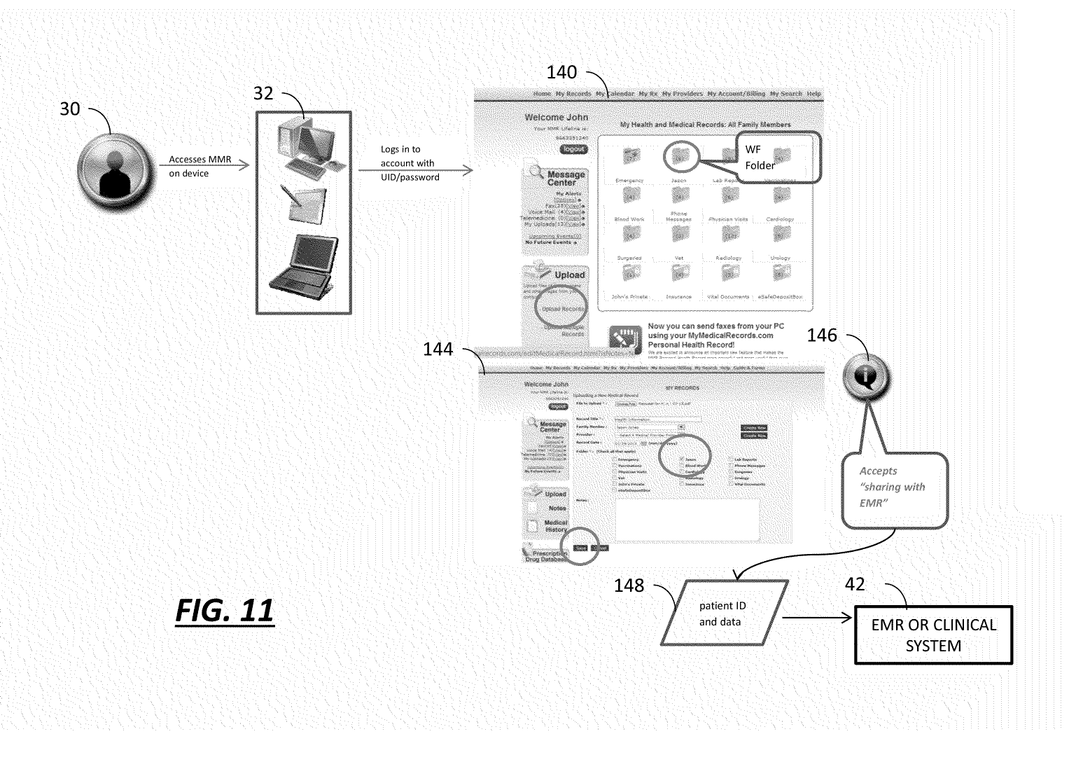

FIG. 11 further illustrates that a user 30 may use a computing device 32 to access their personal health record service and may select a folder from screen display 140 and may upload one or more documents to the folder such as is shown in screen display 140. Similarly, a user can select to share the uploaded document with an EMR and when this selection is made, patient ID and data 148 may be communicated to a the EMR, EHR or health information exchange service such as 4medica 42.

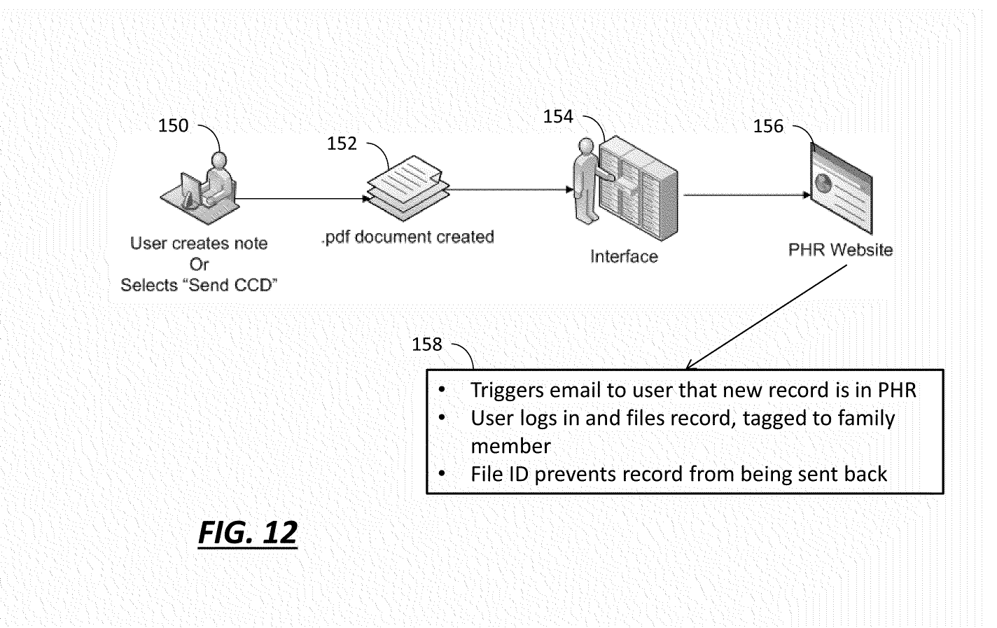

FIG. 12 illustrates a use case where data from an electronic medical record is communicated to a personal health record. In step 150, a user creates a not or selects to send any clinical document, such as continuity of care document (CCD). In step 152 an image file document such as a PDF document may then be created and communicated to an interface 154 thereby making the record available on the personal health record website 156. In step 158, an email may be sent to the user to indicate that the new record is available at the personal health record website. The user may then log in and file the record, tagging it to an appropriate family member if appropriate. The File ID for the document created may be prevented from being sent back to the health information exchange service.

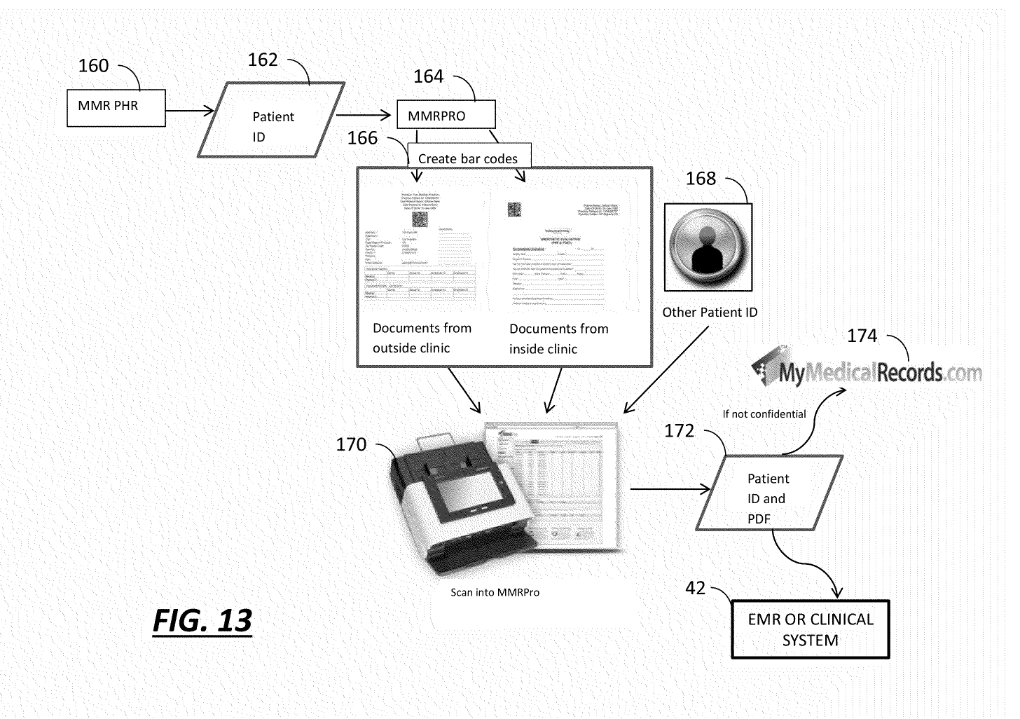

FIG. 13 illustrates scanning of data at a health care provider, such as for a health care provider using an MMRPro system available from MMRGlobal, Inc. In step 160 there is a personal health record and in step 162 that personal health record is associated with a patient ID. That information may be communicated to the system at the clinic 164 where bar codes may be created 166 for documents from outside the clinic as well as for documents from inside the clinic. Another patient ID may also be created in step 168. In step 170, the records with the bar codes may be scanned into the system at the clinic and then in step 172 the patient ID and a file containing the records may be communicated to the personal health record service 174 or to the EMR, EHR or health information exchange service 42.

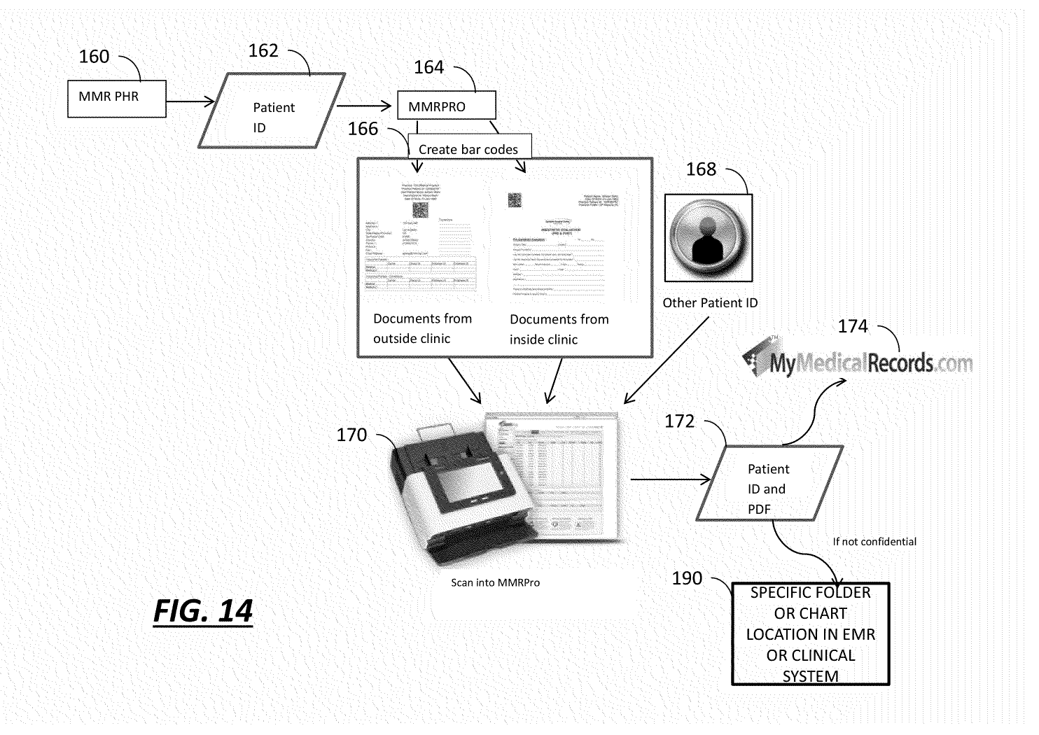

FIG. 14 illustrates another example of a use case. In FIG. 14, documents may push into a specific chart location or folder 190 within the EMR, EHR, or clinical system. It is contemplated that document may be filed in a confidential folder in the EMR, EHR, or clinical system and if this is the case, the document is not pushed into the PHR.

Thus, the provision of a medical record number for records in a personal health record service can be beneficial in providing data interchange through a health information exchange service or any EMR or EHR system because information in the personal health record can be delivered in a variety of formats, including HL7 and PDF. In addition, note that the medical record number can include information beyond merely a unique identifier which identifies a patient or their information within a particular organization. Instead, the medical record number can include a destination address that provides a means for receiving secure and private communications from one or more health care providers.

Additional benefits of the use of the MRN relate to facilitating electronic exchange of information between the personal health record service and services such as 4medica or other services which may provide for the exchange of health data between various organizations including laboratories, radiology systems, pharmacies, as well as health care providers. Such systems may have a master patient index with a record locator to provide access to patient information from multiple providers. Such systems may also use date of birth or other demographic information to find records and properly correlate the records with an individual.

Registration and assessment forms may also be completed through the personal health record service or uploaded and then communicated to one or more health care providers in the same fashion. Thus, various advantages are provided.

Thus, the personal health record service still allows an individual to be in control of their own records independently from health care providers yet provides for obtaining records from health care providers and sharing records with health care providers, including documents such as registration documents and health assessments.

What is claimed:

1. A method of interoperability for health records, comprising:
registering an individual with a personal health record service;
generating a medical record number at the personal health record service using a computing device associated with the personal health record service;
electronically sending health data between the personal health record service and one or more health information technology systems by sending health data and the medical record number to the one or more health information technology systems.

2. The method of claim 1 wherein the step of generating a medical record number comprises generating the medical record number using a destination address associated with the individual on the personal health record service.

3. The method of claim 2 wherein the destination address comprises a phone number.

4. The method of claim 3 wherein the step of generating the medical record number further comprises using a family member number.

5. The method of claim 1 wherein the registering the individual comprises collecting demographic data from the individual.

6. The method of claim 5 wherein the demographic data comprises a date of birth for the individual.

7. The method of claim 1 receiving a user input from the individual indicating that the health data is to be exchanged with the one or more health information technology systems.

8. The method of claim 1 wherein the health data comprises a health care provider registration form.

9. The method of claim 1 wherein the health data comprises a health assessment form.

10. The method of claim 1 further comprising delivering the health data to a health care provider.

11. The method of claim 1 further comprising receiving health data from a health care provider to the personal health record service.

12. The method of claim 1 wherein the health data is in an image file format.

13. The method of claim 12 wherein the health data is a PDF format.

14. The method of claim 1 wherein the health data is in an HL7 format.

15. The method of claim 1 further comprising electronically receiving the health data and the medical record number at a health information technology system.

16. A non-transitory computer readable storage medium comprising a medical record number stored thereon and generated by a personal health record service, the medical record number identifying a user of the personal health record service.

17. The non-transitory computer readable storage medium of claim 16 wherein the medical record number comprises a destination address associated with the user of the personal health record service.

18. The non-transitory computer readable storage medium of claim 16 wherein the destination address comprises a phone number.

19. The non-transitory computer readable storage medium of claim 18 wherein the medical record number further comprises a family member number.
